(19) United States
(12) Patent Application Publication
(10) Pub. No.: US 2008/0202600 A1
(43) Pub. Date: Aug. 28, 2008

(54) Tank Refuelling System

(75) Inventors: Adam R. Peattie, New South Wales (AU); Shane Keys, New South Wales (AU)

Correspondence Address: STITES & HARBISON PLLC, 1199 NORTH FAIRFAX STREET, SUITE 900, ALEXANDRIA, VA, 22314, US

(73) Assignee: BANLAW PIPELINE PTY LTD, New South Wales (AU)

(21) Appl. No.: 10/573,177

(22) PCT Filed: Sep. 23, 2004
(86) PCT No.: PCT/AU2004/001302

§ 371 Date: May 5, 2008

(30) Foreign Application Priority Data
Sep. 23, 2003 (AU) 2003248297

(51) Int. Cl. F16K 31/30; B67D 5/372; G01F 23/30

(52) U.S. Cl. 137/429; 251/62; 137/386; 73/319

(57) ABSTRACT

The present invention relates generally to a fluid level control system comprising a level sensor (10), and a valve in the form of a shut-off valve (12). The level sensor (10) is mounted to a vessel (not shown) and designed to sense the level of fluid, such as fuel, in the vessel. The shut-off valve (12) is designed to be actuated by a dry-break refuelling nozzle (not illustrated). The shut-off valve (12) is operatively coupled to the level sensor (10) via a sampling flow line (14) together with first and second hydraulic return lines (16) and (18), respectively. The shut-off valve (12) is of a normally-open configuration wherein it permits the flow of fuel from the refuelling nozzle to the vessel whilst the fluid or fuel level is below a predetermined level. The level sensor (10) is configured to effect closure of the shut-off valve (12) when the fuel level is at the predetermined level.

### FIELD OF THE INVENTION

The present invention relates broadly to a valve, a fluid level control system, and a fluid level sensor. The invention relates particularly, though not exclusively, to a tank refuelling system designed to be used in conjunction with a dry-break refuelling nozzle.

### BACKGROUND TO THE INVENTION

“Quick-Fill” diesel refuelling technology is often the system of choice for large diesel vehicle operators in many mining, rail, and earthmoving industries. The system typically comprises a dry-break dispensing nozzle, dry-break fuel receiver and tank vent(s). The nozzle is manually turned on to allow fuel to flow into the tank via the receiver. The nozzle shut-off mechanism is sensitive to fluid pressure conveyed through the nozzle. Pressurisation of the fuel tank is required to shut-off the pressure sensitive nozzle, and thus terminate the flow of fuel into the tank. A refuelling nozzle and system of this type are disclosed in the applicant's U.S. Pat. No. 4,919,174 and Australian patent No. 586085.

As occupational health and safety (OH&S) and environmental issues become an increasing priority with many quick-fill users, pressurisation of the fuel tank is often undesirable and in some cases prohibited. This has in turn created the need for a system that will terminate the flow of fuel into a tank without the need for tank pressurisation.

U.S. patent application Ser. No. 10/052909 by Cortex et al discloses a refuelling system and fuel receiver designed to shut-off without requiring pressurisation of the fuel tank. The fuel receiver is in the form of a dual valve receiver having a valve poppet and a piston shuttle located at its inlet and outlet, respectively. The dual valve receiver is normally closed wherein the valve poppet and the piston shuttles are urged closed via respective springs. The system includes a level sensor which controls the flow of fuel to the dual valve receiver so that, when the fuel tank is not full, hydraulic fuel taken from an inlet of the receiver flows to a chamber adjacent the piston shuttle to force the piston open and to permit the flow of fuel to the fuel tank. When the fuel tank is full, the supply of hydraulic fuel to the chamber via the level sensor is interrupted and the spring forces the piston and the dual valve receiver into its normally closed condition.

### SUMMARY OF THE INVENTION

According to one aspect of the present invention there is provided a valve comprising:
a valve body having an elongate fluid passageway defining an inlet and an outlet at its respective ends;
an outlet valve head being slidably disposed within the fluid passageway for closure of the outlet, the outlet valve head being arranged for hydraulic actuation; and
a biasing element being operatively coupled to the outlet valve head to urge it out of sealing engagement with the outlet to permit the flow of fluid through the valve in its normally open configuration.

Preferably the outlet valve head is connected to a piston which is slidably received within a piston chamber of a piston housing mounted within the valve body. More preferably the biasing element is located within the piston chamber and arranged to urge the piston away from the outlet and the outlet valve head out of the sealing engagement with the outlet wherein the valve is in the normally open configuration to allow the flow of fluid therethrough. Even more preferably the piston chamber includes a hydraulic chamber being arranged so that hydraulic fluid pressure applied to the hydraulic chamber drives the piston toward the outlet and the outlet head into sealing engagement with the outlet to dose the valve.

Preferably the valve also comprises an inlet valve head slidably received within the fluid passageway for closure of the inlet.

Preferably the inlet valve head is in the form of a receiver poppet which is slidably received within a poppet chamber of a poppet housing mounted within the valve body. More preferably the valve also includes a poppet biasing element located within the poppet chamber and arranged to urge the receiver poppet toward and into sealing engagement with the inlet

According to another aspect of the invention there is provided a fluid level control system comprising:
a level sensor being adapted to mount to a vessel for sensing the level of its fluid contents;
a valve being adapted to connect to the vessel and hydraulically coupled to the level sensor to control the flow of fluid to the vessel, the valve including a valve body having an elongate fluid passageway defining an inlet and an outlet at its respective ends; and
an outlet valve head being slidably disposed within the fluid passageway for closure of the outlet, the valve being of a normally open configuration wherein the outlet valve head is urged out of sealing engagement with the outlet to permit the flow of fluid through the valve whilst the fluid level is below a predetermined level to permit the flow of fluid to the vessel whereas at or above the predetermined level the level sensor hydraulically actuates the outlet head to effect closure of the valve to at least restrict the flow of fluid to the vessel.

Preferably the fluid level control system also comprises an inlet valve head being slidably and axially disposed within the passageway for closure of the inlet.

According to a further aspect of the invention there is provided a fluid level sensor comprising:
a float device being adapted to locate within a vessel for sensing the level of its fluid contents; and
a level sensor valve being coupled to or arranged to engage the float device, the level senor valve being adapted to couple to a valve and the float device being arranged to move said sensor valve into a first position at a predetermined level of fluid within the vessel whereby the sensor valve permits the flow of a hydraulic fluid to the valve to effect its closure.

Preferably the level sensor valve includes a sensor body having a recess within which a spool is slidably housed, the spool being operatively coupled to or arranged to engage the float device via a connecting rod. More preferably the sensor body includes a hydraulic flow passage which with the fluid level at or above the predetermined level and the level sensor valve in the first position, cooperates with the recess in order to permit the flow of hydraulic fluid to the valve whereas in a second position the spool prevents the flow of hydraulic fluid to the valve whilst the fluid level in the vessel is below the predetermined level.

Preferably the body of the valve includes a sampling port operatively coupled to the level sensor valve to provide hydraulic fluid to said level sensor and with the level sensor valve in the first position, to redirect it to a hydraulic chamber of the valve. More preferably the sampling port is connected to an inlet of the hydraulic flow passage of the sensor body via a sampling flow line which includes an in-line strainer, check valve and/or pressure accumulator. Even more preferably the fluid level sensor includes a first hydraulic return line connected between a first outlet of the hydraulic flow passage and the hydraulic chamber of the valve. In these embodiments the hydraulic fluid is the fluid of the vessel.

Preferably the fluid level sensor includes a float chamber within which the float device is located, the float chamber arranged to be flooded by the vessel fluid at the predetermined level. More preferably the float chamber includes one or more apertures about its peripheral wall and which permit flooding of the chamber which includes a non-return valve in its base which permits flow out of the chamber only.

Preferably the piston housing of the valve body includes a hydraulic inlet to which the level sensor valve is operatively coupled, the hydraulic inlet being arranged, with the level sensor valve in the second position, to provide hydraulic fluid pressure to the piston on an opposite face to the hydraulic chamber whereby the hydraulic fluid assists the biasing element in retaining the valve in the normally open mode. More preferably the hydraulic inlet is coupled to a second outlet of the hydraulic flow passage via a second hydraulic return line. Even more preferably the spool of the level sensor valve includes a throughgoing passage which, with said sensor valve in the second position, cooperates with the hydraulic flow passage to provide hydraulic fluid to the second outlet only and thus hydraulic fluid to the opposite face of the piston. Still more preferably the piston housing includes another hydraulic inlet to which the sensor valve is operatively coupled and being arranged to provide hydraulic fluid pressure to the piston to assist the biasing element in retaining the valve in its open configuration.

Preferably the fluid level control system is used in conjunction with a refuelling nozzle. More preferably the refuelling nozzle is of a dry break configuration and designed to engage the inlet valve head or the receiver poppet to effect its opening.

### BRIEF DESCRIPTION OF THE FIGURES

In order to achieve a better understanding of the nature of the present invention a preferred embodiment of a fluid level control system together with a valve and a fluid level sensor will now be described, by way of example only, with reference to the accompanying drawings in which:

FIG. 1 is a schematic representation of a fluid level control system according to one embodiment of the invention;

FIG. 2 is a sectional view of a valve of the system of FIG. 1; and

FIG. 3 is a sectional view of a fluid level sensor showing a sensor valve in its upward (first) and downward (second) positions in the right and left hand representations, respectively.

### DETAILED DESCRIPTION OF THE PREFERRED EMBODIMENT

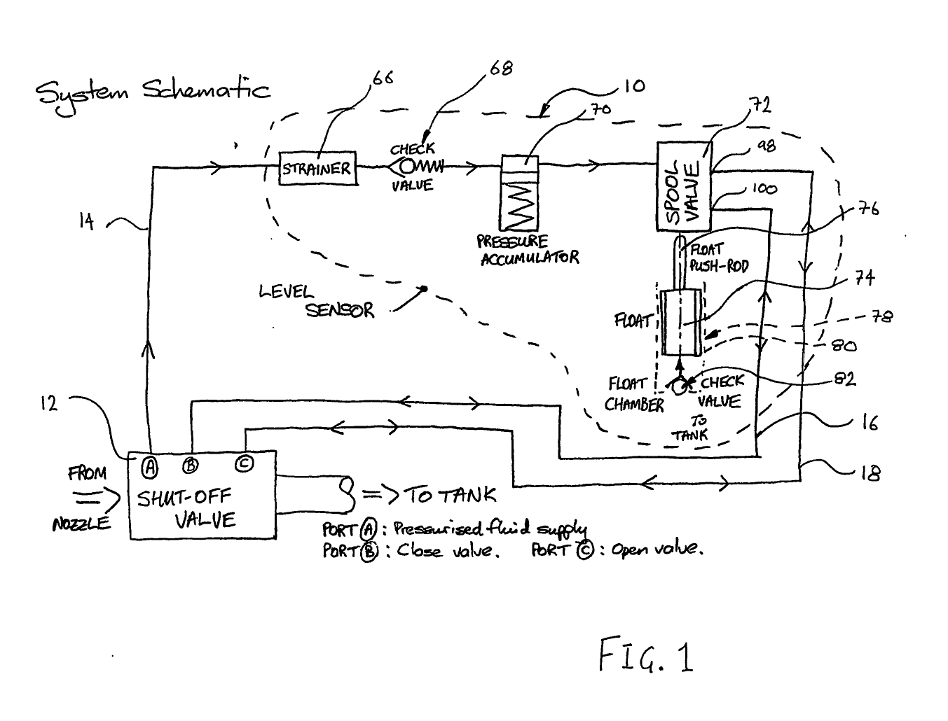

As shown in FIG. 1 there is a fluid level control system comprising a level sensor designated generally as 10, and a valve in the form of a shut-off valve 12. The level sensor 10 is mounted to a vessel (not shown) and designed to sense the level of fluid, such as fuel, in the vessel. The shut-off valve 12 is in this example designed to be actuated by a dry-break refuelling nozzle (not shown) such as that of the applicant's U.S. Pat. No. 4,919,174.

The shut-off valve 12 is operatively coupled to the level sensor 10 via a sampling flow line 14 together with first and second hydraulic return lines 16 and 18, respectively. The shut-off valve 12 is of a normally-open configuration wherein it permits the flow of fuel from the refuelling nozzle to the vessel or tank (not illustrated) whilst the fluid or fuel level is below a predetermined level. The level sensor 10 is configured to effect closure of the shut-off valve 12 when the fuel level is at the pre-determined level, which is most typically the maximum level of fuel within the tank when it is deemed to be full.

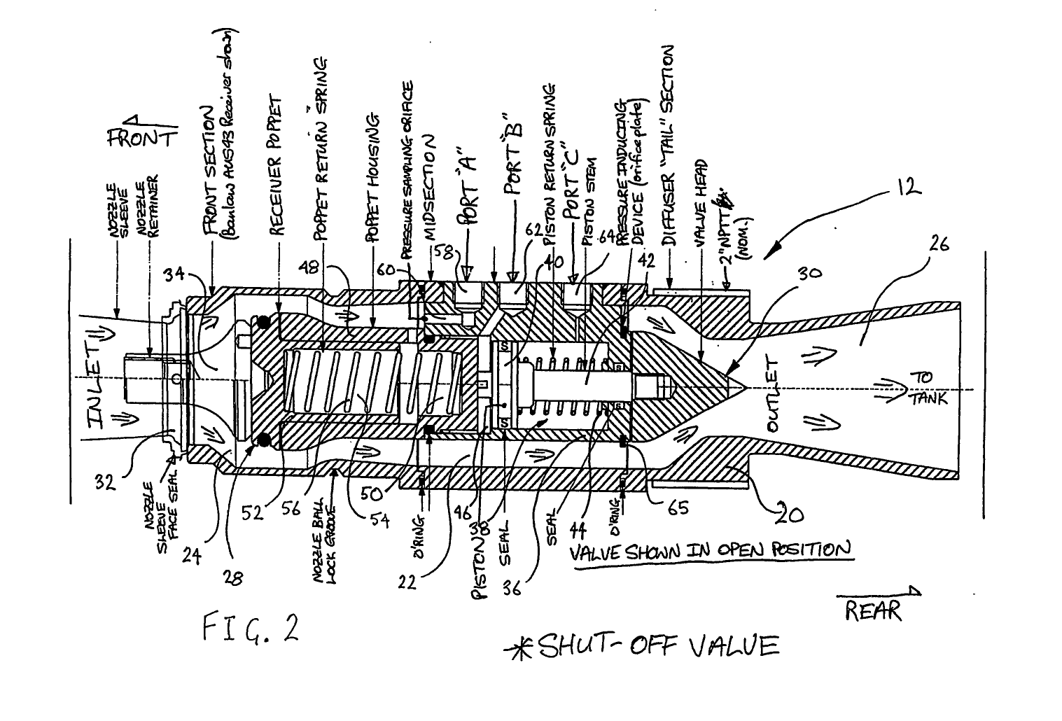

As shown in FIG. 2 the shut-off valve 12 includes a valve body 20 which is elongate and shaped generally cylindrical with an axially disposed fluid or fuel passageway 22. The fluid passageway 22 includes an inlet 24 and an outlet 26 at or adjacent its respective ends. The shut-off valve 12 also includes an inlet valve head 28 and an outlet valve head 30 slidably and coaxially received within the fluid passageway 22 at or adjacent to the fuel inlet 24 and the fuel outlet 26, respectively. The shut-off valve 12 is in operation of a normally-open configuration wherein the outlet valve head 30 is urged or biased out of sealing engagement with the fuel outlet 26. In use, the inlet valve head 28 is engaged by the refuelling nozzle (not shown) and a sleeve 32 of the refuelling nozzle abuts and seals with the fuel inlet 24 of the shut-off valve 12. The refuelling nozzle in its “on mode” includes a valve poppet 34 which abuts the inlet valve head 28 and forces it out of sealing engagement with the fuel inlet 24 to allow the flow of fuel through the shut-off valve 12.

The shut-off valve 12 also includes a piston housing 36 mounted to the valve housing 20 adjacent to the fuel outlet 26 and including a piston chamber 38 of a generally cylindrical configuration and arranged coaxial with the fuel passageway 22. The piston chamber 38 slidably houses a piston 40 which is connected to the valve head 30 via a connecting rod 42 and urged away from the fuel outlet 26 via a biasing element in the form of a piston return spring 44 which locates about the connecting rod 42. Thus, the piston 40 ordinarily retains the outlet valve head 30 out of sealing engagement with the fuel outlet 26 to permit the flow of fuel in the normally-open mode of the shut-off valve 12. The piston chamber 38 includes a hydraulic chamber 46 located adjacent a front face of the piston 40 so that hydraulic pressure within this chamber 46 drives the piston 40 against the return spring 44 force toward the fuel outlet 26 and the outlet head 30 into sealing engagement with the fuel outlet 26 so as to close the valve 12. In this example the outlet valve head 30 is of a conical shape and designed to mate with a corresponding internal surface of the fuel passageway 22 and the fuel outlet 26.

The shut-off valve 12 also includes a poppet housing 48 which is of a cylindrical shape and is mounted to the valve housing 20 coaxially within the fuel passageway 22 adjacent the fuel inlet 24. The poppet housing 48 includes a poppet chamber 50 within which the inlet valve head in the form of a receiver poppet 52 is slidably received. The receiver poppet 52 includes a coaxial bore 54 within which a poppet biasing element in the form of poppet spring 56 is housed. The poppet return spring 56 urges the receiver poppet 52 into sealing engagement with the fuel inlet 24 when the refuelling nozzle is disconnected from the shut-off valve 12 or the refuelling nozzle is in the “off mode”.

The valve body 20 includes a sampling port 58 located in this example approximately mid-way along the body 20 and in fluid communication with the fuel passageway 22. The sampling port 58 includes a sampling orifice 60 being arranged so as to increase the static pressure of the hydraulic fluid which in this example is the fuel sampled from the fuel passageway 22. The valve body 20 further includes a hydraulic inlet 62 in fluid communication with the hydraulic chamber 46 only. The valve body 20 includes another hydraulic inlet 64 which is arranged to provide hydraulic fluid to the hydraulic chamber 38 in the space rearward of the piston 40 and disposed about the piston return spring 44.

The shut-off valve 12 also includes a pressure inducing device located within the fuel passageway 22 adjacent the outlet valve head 30. In this example the pressure inducing device is in the form of an orifice plate 65 and is designed to “artificially” create an increase in the magnitude of pressure drop across the valve 12 thus increasing the amount of static pressure available at the sampling orifice 60. The system may have a minimal threshold pressure to ensure it operates and in applications where insufficient pressure is generated either through the valve 12, or downstream of the valve 12, the orifice plate 65 is installed to generate pressure at the sampling orifice 60 in excess of the minimal system pressure. Varying diameters or sizes of the orifice plate 65 can be used to create varying degrees of pressure increase. For example, refuelling applications having relatively high flowrates and inherently high downstream pressure head will require a “low restriction” device. Conversely, applications with low flowrates and negligible downstream pressure head will require a “high restriction” device.

As shown in FIG. 1 the level sensor 10 includes a strainer 66, a hydraulic check valve 68, and a pressure accumulator 70 positioned adjacent to one another within the sampling flow line 14. The level sensor 10 also includes a level sensor valve or in this example a spool valve 72 which is arranged to be engaged or abutted by an end of a connecting rod 76 which at an opposite end is connected to a float device 74. The float device 74 is located within a float chamber 78 mounted within the fuel vessel or tank (not shown) and designed to be flooded by fuel at the pre-determined fuel level. The float chamber 78 includes one or more apertures (not illustrated) about its peripheral wall 80 and which permit flooding of the chamber 78. A non-return or check valve 82 is included in the base of the chamber 78 and permits fluid or fuel to exit the chamber 78 only so that controlled actuation of the spool valve 72 is effected on flooding of the chamber 78.

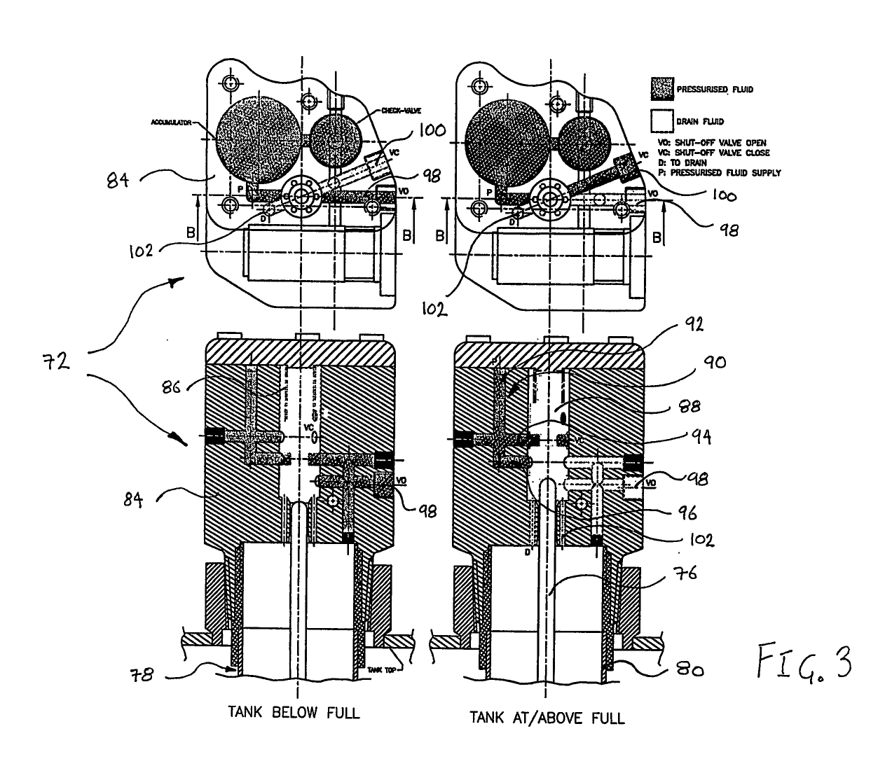

FIG. 3 illustrates the spool valve 72 in its upward (first), and downward or home (second) positions in the right and left hand representations, respectively. The spool valve 72 includes a sensor body 84 having a cylindrical-shaped recess 86 within which a spool 88 is slidably housed. The spool 88 is designed to be abutted by the end of the connecting rod 76. The sensor body 84 includes a hydraulic flow passage 90 having an inlet or port 92 formed continuous with a pair of passageways 94 and 96 which communicate with first and second outlets 98 and 100 (depending on the position of the spool 88), respectively. The first and second passageways 94 and 96 adjacent to the respective outlets 98 and 100 are connected to a drain port 102 for the relief of hydraulic fluid from these passageways 94 and 96.

In order to further describe the invention, operation of this embodiment of the fluid level control system will now be explained. The general steps involved in its operation are as follows:
1. a refuelling nozzle (not illustrated) is connected to the shut-off valve 12 at its fuel inlet 24;
2. the refuelling nozzle is turned on wherein the poppet 34 of the refuelling nozzle engages the receiver poppet 52 which is unseated so as to open the fuel inlet 24;
3. fuel or any other fluid flows through the fuel passageway 22 of the shut-off valve 12 and fills the vessel tank (not shown);
4. the sampling port 58 samples fluid from the fuel passageway 22 and delivers it to the pressure accumulator 70 via the sampling flow line 14;
5. the charged pressure accumulator 70 provides hydraulic fuel to the hydraulic inlet 64 of the piston housing 36 via the hydraulic return line 18 with the spool valve 72 in its home or downward position (second position) as shown in the left hand representation of FIG. 3;
6. the hydraulic fuel provided to the hydraulic inlet 64 provides hydraulic pressure to the piston 40 to assist the return spring 44 in retaining the outlet valve head 30 in its open configuration, and any fluid pressure within the hydraulic chamber 46 on the forward side of the piston 40 is exhausted into the fuel tank via the hydraulic return line 16, the second outlet 100 and the drain port 102 as shown in the left hand representation of FIG. 3;
7. fuel or fluid will continue to flow through the shut-off valve 12 into the tank until the predetermined level is reached wherein fuel will flood the float chamber 78 and the float device 74 will rapidly rise forcing the connecting rod 76 upward into abutment with the spool 88 which is also moved upward;
8. the spool valve 72 is thus moved into its upward position (first position) as shown in the right hand representation of FIG. 3 wherein the hydraulic fluid or fuel is redirected, via the throughgoing passage of the spool 88 and the second outlet 100, to the hydraulic inlet 62 and the hydraulic chamber 46 onto a forward face of the piston 40 so as to urge the piston 40, against the return spring 44 force, together with the valve head 30 toward the fuel outlet 26;
9. any hydraulic fluid pressure on the rearward face of the piston 40 within the piston chamber 38 is exhausted into the fuel tank via the hydraulic port 64, the corresponding hydraulic return line 18, the first outlet 98 and the drain port 102 as shown in the right hand representation of FIG. 3;
10. the shut-off valve 12 increases the fuel or fluid pressure within the fuel passageway 22 and upstream of the shut-off valve 12 wherein the quick-fill refuelling nozzle is automatically shut-off;
11. the refuelling nozzle can then be disconnected from the shut-off valve 12.

If the refuelling nozzle is not of a pressure-sensitive design for automatic shut-off, the refuelling nozzle is closedmanually. In any event the shut-off valve 12 is retained in the closedposition whilst the fluid or fuel level in the vessel or tank is at the predetermined level. Hydraulic fluid pressure is maintained within the hydraulic chamber 46 by hydraulic fluid or fuel from the pressure accumulator 70. Therefore, if the refuelling nozzle is inadvertently turned on, no fuel will pass the shut-off valve 12 and enter the vessel or tank. If a non-pressure sensitive refuelling nozzle such as a bulk-fill coupling is used, the system will retain the shut-off valve 12 in its closed mode with the vessel or tank full and the refuelling nozzle connected.

Now that a preferred embodiment of the present invention has been described in some detail it will be apparent to those skilled in the art that the fluid level control system together with the other aspects of the invention have at least the following advantages:
1. the preferred shut-off valve relies on a combination of the biasing means and hydraulic fluid pressure in retaining the valve in its normally-open configuration;
2. the preferred valve is of a normally-open design and relies upon hydraulic fluid pressure alone in effecting its closure;
3. the fluid level control system need not rely solely on tank pressurisation in providing automatic shut-off but rather operates independent of tank pressure;
4. the fluid level control system provides a fail-safe mechanism to prevent the flow of fuel to the tank or vessel when the fluid level is already at the predetermined or generally maximum level;
5. the shut-off valve of the preferred example is relatively unobstructive to the passage of fuel and as such provides quick-filling of tanks or vessels.

Those skilled in the art will appreciate that the invention described herein is susceptible to variations and modifications other than those specifically described. For example, the construction and configuration of the valve may vary from that of the shut-off valve described provided it functions as broadly defined in the specification. The valve may be of a single head configuration without the inlet head of the described example of the shut-off valve. For example, the shut-off valve may involve the omission of the front receiver section, replaced by a pipe connection (threaded or flanged). This connection would accept hose or pipework leading from the upstream receiver (and nozzle). The poppet housing and associated components would be replaced by a conical head piece. The role of this head piece would be to direct the flow, in the most efficient manner, to the flow passageway surrounding the piston housing.

All such variations and modifications are to be considered within the scope of the present invention, the nature of which is to be determined from the foregoing description.

1. A valve comprising:
a valve body having an elongate fluid passageway defining an inlet and an outlet at its respective ends;
an outlet valve head being slidably disposed within the fluid passageway for closure of the outlet, the outlet valve head being arranged for hydraulic actuation; and
a biasing element being operatively coupled to the outlet valve head to urge it out of sealing engagement with the outlet to permit the flow of fluid through the valve in its normally open configuration.

2. A valve as claimed in claim 1 wherein the outlet valve head is connected to a piston which is slidably received within a piston chamber of a piston housing mounted within the valve body.

3. A valve as claimed in claim 2 wherein the biasing element is located within the piston chamber and arranged to urge the piston away from the outlet and the outlet valve head out of the sealing engagement with the outlet wherein the valve is in the normally open configuration to allow the flow of fluid therethrough.

4. A valve as claimed in claim 2 wherein the piston chamber includes a hydraulic chamber being arranged so that hydraulic fluid pressure applied to the hydraulic chamber drives the piston toward the outlet and the outlet head into sealing engagement with the outlet to close the valve.

5. A valve as claimed in claim 1 also comprising an inlet valve head slidably disposed within the fluid passageway for closure of the inlet.

6. A valve as claimed in claim 5 wherein the inlet valve head is in the form of a receiver poppet which is slidably received within a poppet chamber of a poppet housing mounted within the valve body.

7. A valve as claimed in claim 6 further comprising a poppet biasing element located within the poppet chamber and arranged to urge the receiver poppet toward and into sealing engagement with the inlet.

8. A fluid level control system comprising:
a level sensor being adapted to mount to a vessel for sensing the level of its fluid contents; p1 a valve being adapted to connect to the vessel and hydraulically coupled to the level sensor to control the flow of fluid to the vessel, the valve including a valve body having an elongate fluid passageway defining an inlet and an outlet at its respective ends; and
an outlet valve head being slidably disposed within the fluid passageway for closure of the outlet, the valve being of a normally open configuration wherein the outlet valve head is urged out of sealing engagement with the outlet to permit the flow of fluid through the valve whilst the fluid level is below a predetermined level to permit the flow of fluid to the vessel whereas at or above the predetermined level the level sensor hydraulically actuates the outlet head to effect closure of the valve to at least restrict the flow of fluid to the vessel.

9. A fluid level control system as claimed in claim 8 further comprising an inlet valve head being slidably and axially disposed within the passageway for closure of the inlet.

10. A fluid level control system as claimed in claim 8 arranged for use in conjunction with a refuelling nozzle.

11. A fluid level control system as claimed in claim 10 wherein the refuelling nozzle is of a dry break configuration and designed to engage the inlet valve head to effect its opening.

12. A fluid level sensor comprising:
a float device being adapted to locate within a vessel for sensing the level of its fluid contents; and
a level sensor valve being coupled to or arranged to engage the float device, the level sensor valve being adapted to couple to a valve and the float device being arranged to move said sensor valve into a first position at a predetermined level of fluid within the vessel whereby the sensor valve permits the flow of a hydraulic fluid to the valve to effect its closure.

13. A fluid level sensor as claimed in claim 12 wherein the level sensor valve includes a sensor body having a recess within which a spool is slidably housed, the spool being operatively coupled to or arranged to engage the float device via a connecting rod.

14. A fluid level sensor as claimed in claim 13 wherein the sensor body includes a hydraulic flow passage which, with the fluid level at or above the predetermined level and the level sensor valve in the first position, cooperates with the recess in order to permit the flow of hydraulic fluid to the valve whereas in a second position the spool prevents the flow of hydraulic fluid to the valve whilst the fluid level in the vessel is below the predetermined level.

15. A fluid level sensor as claimed in claim 14 wherein the body of the valve includes a sampling port operatively coupled to the level sensor valve to provide hydraulic fluid to said level sensor and with the level sensor valve in the first position, to redirect it to a hydraulic chamber of the valve.

16. A fluid level sensor as claimed in claim 15 wherein the sampling port is connected to an inlet of the hydraulic flow passage of the sensor body via a sampling flow line which includes an in line strainer, check valve and/or pressure accumulator.

17. A fluid level sensor as claimed in claim 14 further comprising a first hydraulic return line connected between a first outlet of the hydraulic flow passage and the hydraulic chamber of the valve.

18. A fluid level sensor as claimed in claim 12 wherein the hydraulic fluid is the fluid of the vessel.

19. A fluid level sensor as claimed in claim 18 further comprising a float chamber within which the float device is located, the float chamber arranged to be flooded by the vessel fluid at the predetermined level.

20. A fluid level sensor as claimed in claim 19 wherein the float chamber includes one or more apertures about its peripheral wall and which permit flooding of the chamber which includes a non return valve in its base which permits flow out of the chamber only.

21. A fluid level sensor as claimed in claim 15 wherein the piston housing of the valve body includes a hydraulic inlet to which the level sensor valve is operatively coupled, the hydraulic inlet being arranged, with the level sensor valve in the second position, to provide hydraulic fluid pressure to the piston on an opposite face to the hydraulic chamber whereby the hydraulic fluid assists a biasing element in retaining the valve in a normally open mode.

22. A fluid level sensor as claimed in claim 21 wherein the hydraulic inlet is coupled to a second outlet of the hydraulic flow passage via a second hydraulic return line.

23. A fluid level sensor as claimed in claim 22 wherein the spool of the level sensor valve includes a throughgoing passage which, with said sensor valve in the second position, cooperates with the hydraulic flow passage to provide hydraulic fluid to the second outlet only and thus hydraulic fluid to the opposite face of the piston.

24. A fluid level sensor as claimed in claim 21 wherein the piston housing includes another hydraulic inlet to which the sensor valve is operatively coupled and being arranged to provide hydraulic fluid pressure to the piston to assist the biasing element in retaining the valve in its open configuration.
